(19) United States
(12) Patent Application Publication
(10) Pub. No.: US 2025/0226881 A1
(43) Pub. Date: Jul. 10, 2025

(54) SYSTEM AND METHOD FOR MONITORING OPTICAL COMMUNICATION CHANNEL

(71) Applicant: Government of the United States of America, as represented by the Secretary of Commerce, Gaithersburg, MD (US)

(72) Inventors: Sergey Vladimirovich Polyakov, Gaithersburg, MD (US); Ivan Alexandrovich Burenkov, Boyds, MD (US); Jabir Marakkarakath Vadakkepurayil, Germantown, MD (US)

(21) Appl. No.: 19/013,394

(22) Filed: Jan. 8, 2025

Related U.S. Application Data
(60) Provisional application No. 63/618,638, filed on Jan. 8, 2024.

(51) Int. Cl. H04B 10/079

(52) U.S. Cl. CPC H04B 10/079

(57) ABSTRACT

Embodiments of the present invention relate to a system and method for monitoring optical communication channel during data transmission using a quantum measurement. Embodiments in accordance with the present invention is capable of estimating channel loss and added phase noise based on the quantum properties of faint light. All measurements utilizing system and method in accordance with embodiments of the present invention are local to the receiver, and additional information (or physical states) exchange between transmitter and receiver is not required.

### CROSS-REFERENCE TO RELATED APPLICATION

This application claims the benefit of priority from U.S. Provisional Patent Application Ser. No. 63/618,638, filed on Jan. 8, 2024, the disclosure of which is incorporated herein by reference in its entirety.

### STATEMENT REGARDING FEDERAL RIGHTS

The invention described herein was made with United States Government support from the National Institute of Standards and Technology (NIST), an agency of the United States Department of Commerce. The United States Government has certain rights in the invention.

### FIELD OF THE INVENTION

The present invention relates generally to communication system, and more particularly, to optical communication channel monitoring using quantum measurement.

### BACKGROUND OF THE INVENTION

Quantum-enabled classical communication is more resource-efficient than conventional classical networks. It uses quantum operations and photon counting to receive information that identify states of light with a sensitivity beyond the shot noise limit. Recent research shows that quantum receivers require as low as about 1 photon/bit to reliably receive a signal. It has been shown that photon detection times can be used to find the most probable state of the input field via Bayesian inference. In addition to identifying the state, many quantum receivers can estimate the accuracy of each state identification measurement separately using Bayesian state identification algorithm. The receiver calculates the Bayesian probabilities called confidences, which reflect an estimate of the reliability of a measurement. A vector of confidences (confidence vector) can be formed using the Bayesian probability values and the confidence vector can be used for error correction. However, the Bayesian algorithm used to estimate the probability values assumes a noiseless communication channel and a particular transmission loss, which does not reflect the receiver's true measured probability values. To recover true probability distribution, the same experiment must be repeated, and the outcomes must be obtained multiple times to acquire statistics of the outcomes. By reconciling the expected and acquired statistics, true measure of phase instability and transmission loss can be inferred. Accordingly, there is a need for an improved system and method for detecting and quantifying the degree of disturbance to the communication channel without reconciliation of the received information.

### SUMMARY OF THE INVENTION

Embodiments of the present invention relate to a system and method for monitoring optical communication channel during data transmission using a quantum measurement. Embodiments in accordance with the present invention is capable of estimating channel loss and added phase noise based on the quantum properties of faint light. All measurements utilizing system and method in accordance with embodiments of the present invention are local to the receiver, and additional information (or physical states) exchange between transmitter and receiver is not required. System and method in accordance with embodiments of the present invention can be combined with other techniques, such as quantum key distribution, quantum channel protection, quantum position verification, and others to enhance those techniques and for added protection against an adversary. Embodiments in accordance with the present invention is capable of quantifying the communication channel properties as they pertain to the classical information exchange without reconciliation of the received information.

Accordingly, embodiments of the present invention relate to a system for monitoring an optical communication channel, said system including a transmitter for generating an encoded input optical signal, wherein the encoded input optical signal is transmitted over the optical communication channel, wherein the encoded input optical signal comprises a plurality of encoded input optical signal states; a receiver for receiving the encoded input optical signal transmitted over the optical communication channel, wherein the receiver includes: a local oscillator for generating a reference optical signal comprising a plurality of displacement operators for displacing at least one of the plurality of the encoded input optical signal states; a beam splitter for splitting the encoded input optical signal at a predetermined transmission to reflection ratio to generate a displaced output optical signal, wherein the encoded input optical signal is combined with the reference optical signal at the beam splitter to generate the displaced output optical signal, wherein the displaced output optical signal has zero optical energy when the encoded input optical state matches the reference optical signal, and wherein the displaced output optical signal has non-zero optical energy when the encoded input optical signal does not match the reference optical signal; a single photon detector in communication with the beam splitter and that receives the displaced output optical signal from the beam splitter; and produces a single photon detector signal based on the displaced output optical signal; a first processor for determining a plurality of confidence vectors of an optical state identification for the at least one of the plurality of the encoded input optical signal states of the encoded input optical signal transmitted over the optical communication channel, wherein the determining the plurality of the confidence vectors of the optical state identification comprises determining a plurality of components for each of the plurality of the confidence vectors, wherein the each of the plurality of the components corresponds to the at least one of the plurality of the encoded input optical signal states and a probability of occurrence of at least one of a plurality of measurement records corresponding to the at least one of the plurality of the encoded input optical signal states for the encoded input optical signal; and a second processor for analyzing the at least one of the plurality of the confidence vectors determined by the first processor, wherein the analyzing the at least one of the plurality of the confidence vectors includes: determining a probability distribution of the plurality of the components for the each of the plurality of the confidence vectors over the plurality of the encoded input optical signal states; and comparing the probability distribution of the plurality of the components for the each of the plurality of the confidence vectors over the plurality of the encoded input optical signal states with a second probability distribution of a plurality of second components for each of a plurality of second confidence vectors over a plurality of expected optical states traversing the optical communication channel comprising at least one of a plurality of reference properties. More particularly, the reference properties are selected from a group comprising channel loss, channel phase noise, interferometric visibility, and dark count rate of the detector. In an exemplary embodiment, the first processor is a field programmable gate array and the second processor is a statistical processor.

In one embodiment, the first processor adjusts the reference optical signal to generate an adjusted reference optical signal, wherein the first processor adjusts the reference optical signal in response to detecting the single photon detector signal at the single photon detector, wherein the adjusted reference optical signal corresponds to the at least one of the plurality of the encoded input optical states having a maximal value of the confidence vector. In another embodiment, the first processor generates a radio frequency signal pulse to adjust the reference optical signal.

In some embodiments of the system for monitoring an optical communication channel, the analyzing the at least one of the plurality of the confidence vectors further includes: determining at least one of a plurality of probabilities of measurement outcomes with a predetermined plurality of detections at the single photon detector; and comparing the at least one of the plurality of probabilities of measurement outcomes to a probability of the expected optical states traversing the optical communications channel comprising the at least one of the plurality of the reference properties.

In some embodiments of the system for monitoring an optical communication channel, the plurality of the measurement records comprises a record of the plurality of the displacement operators selected for displacing the at least one of the plurality of the encoded input optical signal states of the received encoded input optical signal and time stamp of the generation of the displaced output optical signal.

Another embodiment of the present invention relate to a method for monitoring an optical communication channel, including: generating at a transmitter an encoded input optical signal, wherein the encoded input optical signal is transmitted over the optical communication channel, wherein the encoded input optical signal comprises a plurality of encoded input optical signal states; receiving at a receiver the encoded input optical signal transmitted over the optical communication channel; generating at a local oscillator a reference optical signal comprising a plurality of displacement operators for displacing at least one of the plurality of the encoded input optical signal states of the received encoded input optical signal; splitting at a beam splitter the encoded input optical signal at a predetermined transmission to reflection ratio to generate a displaced output optical signal, wherein the encoded input optical signal is combined with the reference optical signal at the beam splitter to generate the displaced output optical signal, wherein the displaced output optical signal has zero optical energy when the encoded input optical state matches the reference optical signal, and wherein the displaced output optical signal has non-zero optical energy when the encoded input optical signal does not match the reference optical signal; detecting at a single photon detector a single photon detector signal, wherein the detecting the single photon detector signal comprises receiving the displaced output optical signal from the beam splitter and producing a single photon detector signal based on the displaced output optical signal; determining at a first processor a plurality of confidence vectors of an optical state identification for the at least one of the plurality of the encoded input optical signal states of the encoded input optical signal transmitted over the optical communication channel, wherein the determining the plurality of the confidence vectors of the optical state identification comprises determining a plurality of components for each of the plurality of the confidence vectors, wherein the each of the plurality of the components corresponds to the at least one of the plurality of the encoded input optical signal states and a probability of occurrence of at least one of a plurality of measurement records corresponding to the at least one of the plurality of the encoded input optical signal states for the encoded input optical signal; and analyzing at a second processor the at least one of the plurality of the confidence vectors determined at the first processor, wherein the analyzing the at least one of the plurality of the confidence vectors includes: determining a probability distribution of the plurality of the components for the each of the plurality of the confidence vectors over the plurality of the encoded input optical signal states; and comparing the probability distribution of the plurality of the components for the each of the plurality of the confidence vectors over the plurality of the encoded input optical signal states with a second probability distribution of a plurality of second components for each of a plurality of second confidence vectors over a plurality of expected optical states traversing the optical communication channel comprising at least one of a plurality of reference properties. More particularly, the plurality of the reference properties is selected from a group comprising channel loss, channel phase noise, interferometric visibility, and dark count rate of the detector.

In one embodiment of the present invention, the method for monitoring an optical communication channel further includes adjusting at the first processor the reference optical signal to generate an adjusted reference optical signal, wherein the reference optical signal is adjusted at the first processor in response to detecting the single photon detector signal at the single photon detector, wherein the adjusted reference optical signal corresponds to the at least one of the plurality of the encoded input optical states having a maximal value of the confidence vector. In another embodiment of the present invention, the method for monitoring an optical communication channel further includes generating at the first processor a radio frequency signal pulse to adjust the reference optical signal.

In some embodiments of the present invention, the analyzing the at least one of the plurality of the confidence vectors further includes: determining at least one of a plurality of probabilities of measurement outcomes with a predetermined plurality of detections at the single photon detector; and comparing the at least one of the plurality of probabilities of measurement outcomes to a probability of the expected optical states traversing the optical communications channel comprising the at least one of the plurality of the reference properties.

In other embodiments of the present invention, the method for monitoring an optical communication channel further includes: selecting at least one of the plurality of the components having a predetermined probability; and transmitting the at least one of the plurality of the selected components to the local oscillator.

In another embodiments of the present invention, the method for monitoring an optical communication channel further includes: generating at the first processor a plurality of measurement records, wherein each of the plurality of the measurement records comprises a record of the plurality of the displacement operators selected for displacing the at least one of the plurality of the encoded input optical signal states of the received encoded input optical signal and time stamp of the generation of the displaced output optical signal; storing at the first processor the generated plurality of the measurement records; and reducing the plurality of the measurement records to a list comprising a plurality of photon detection times.

Embodiments of the present invention also relate to a method for monitoring an optical communication channel, including: receiving at a receiver an encoded input optical signal transmitted by a transmitter over the optical communication channel, wherein the encoded input optical signal comprises a plurality of encoded input optical signal states; generating at a local oscillator a reference optical signal comprising a plurality of displacement operators for displacing at least one of the plurality of the encoded input optical signal states of the received encoded input optical signal; splitting at a beam splitter the encoded input optical signal at a predetermined transmission to reflection ratio to generate a displaced output optical signal, wherein the encoded input optical signal is mixed with the reference optical signal at the beam splitter to generate the displaced output optical signal, wherein the displaced output optical signal has zero optical energy when the encoded input optical state matches the reference optical signal, and wherein the displaced output optical signal has non-zero optical energy when the encoded input optical signal does not match the reference optical signal; detecting at a single photon detector a single photon detector signal, wherein the detecting the single photon detector signal comprises receiving the displaced output optical signal from the beam splitter and producing a single photon detector signal, based on the displaced output optical signal; adjusting at a first processor the reference optical signal to generate an adjusted reference optical signal, wherein the reference optical signal is adjusted in response to the detection of the single photon detector signal at the single photon detector, wherein the adjusted reference optical signal corresponds to the at least one of the plurality of the encoded input optical states having a maximal value of the confidence vector; determining at the first processor a plurality of confidence vectors of an optical state identification for the at least one of the plurality of the encoded input optical signal states of the encoded input optical signal transmitted over the optical communication channel, wherein the determining the plurality of the confidence vectors of the optical state identification comprises determining a plurality of components for each of the plurality of the confidence vectors, wherein the each of the plurality of the components corresponds to the at least one of the plurality of the encoded input optical signal states and a probability of occurrence of at least one of a plurality of measurement records corresponding to the at least one of the plurality of the encoded input optical signal states for the encoded input optical signal; selecting at least one of the plurality of the components having a predetermined probability; and transmitting at least one of the plurality of the confidence vectors of the optical communication channel; and analyzing at a second processor the at least one of the plurality of the confidence vectors determined at the first processor, wherein the analyzing the at least one of the plurality of the confidence vectors includes: determining a probability distribution of the plurality of the components for the each of the plurality of the confidence vectors over the plurality of the encoded input optical signal states; and comparing the probability distribution of the plurality of the components for the each of the plurality of the confidence vectors over the plurality of the encoded input optical signal states with a second probability distribution of a plurality of second components for each of a plurality of second confidence vectors over a plurality of expected optical states traversing the optical communication channel comprising at least one of a plurality of reference properties. In some embodiments of the present invention, the method for monitoring an optical communication channel further includes generating at a transmitter the encoded input optical signal, wherein the encoded input optical signal is transmitted over the optical communication channel.

### BRIEF DESCRIPTION OF DRAWINGS

FIG. 1 illustrates a channel monitoring system in accordance with embodiments of the present invention.

FIG. 2 illustrates a quantum receiver of channel monitoring system in accordance with an embodiment of the present invention.

FIG. 3 illustrates exemplary time-resolved photon detections at single photon detector of optical communication channel in accordance with an embodiment of the present invention.

FIG. 4 illustrates a method for monitoring optical communication channel in accordance with an embodiment of the present invention.

FIG. 5 illustrates a constellation diagram of M=4 coherent states that are modulated in phase.

FIG. 6 illustrates an example of the evolution of Bayesian probabilities \vec{P}(t), known as Confidence Vector in a process of single-shot measurement, where t1, t2, t3 are single photon detection times, cf. FIG. 3. \vec{P}(t=T) is the confidence vector associated with a completed single measurement.

FIG. 7 illustrates exemplary probability distribution of confidence vectors estimated using channel monitoring system in accordance with embodiments of the present invention.

FIG. 8A and FIG. 8B illustrate the experimentally measured probability to obtain a confidence vector values with one high value of the confidence component for channels with different disturbances, with FIG. 8(A) showing disturbances in received power and FIG. 8(B) showing disturbances of interferometric visibility (correlated with uncontrolled phase noise), for an exemplary channel monitoring system in accordance with embodiments of the present invention.

FIG. 9A and FIG. 9B illustrate the simulation results of the dependence on the transmission channel parameters (received power, phase noise) of (A) High Confidence Probability ratio and (B) Excess photon detection probability of an exemplary channel monitoring system in accordance with embodiments of the present invention.

FIG. 10 illustrates an alternate view of the plot shown in FIG. 9 for a range of small deviations of the measured channel from the assumed channel.

### DETAILED DESCRIPTION

While the making and using of various embodiments of the present invention are discussed in detail below, it should be appreciated that the present invention provides many applicable inventive concepts which can be embodied in a wide variety of specific contexts. The specific embodiments discussed herein are merely illustrative of specific ways to make and use the invention, and do not delimit the scope of the present invention. Reference will now be made to the drawings wherein like numerals refer to like elements throughout.

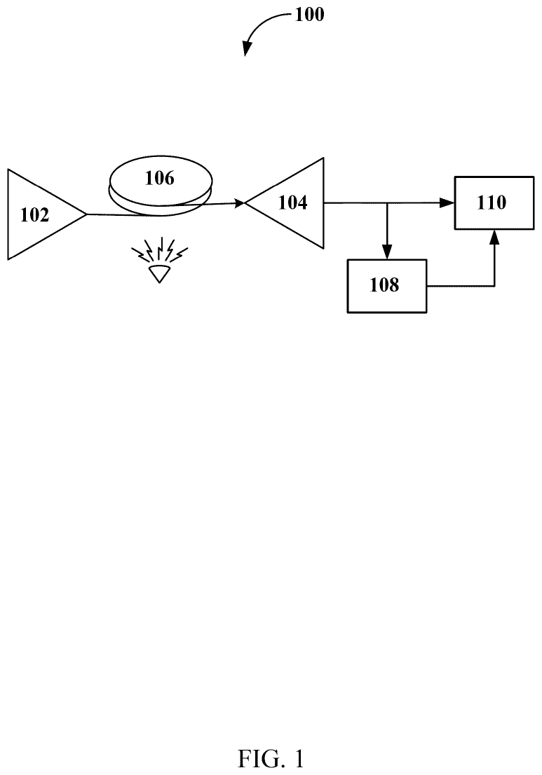

Referring now to the drawings, and more particularly, to FIG. 1, there is shown a channel monitoring system, generally designated 100 and schematically showing an embodiment of the present invention. Channel monitoring system 100 includes a transmitter 102, a quantum receiver 104, an optical communication channel 106 for coupling transmitter 102 and receiver 104, a statistical processor 108, and a digital processing unit 110.

Transmitter 102 includes a laser light source for transmitting a stream of modulated optical pulses. Although a laser light source is described, other sources may possibly be used that generate the stream of optical pulses. In one embodiment, one or more light-emitting diodes may be used to generate the stream of optical pulses. Transmitter 102 includes a controller operatively connected to the laser light source and other components at the transmitter node for controlling their operation, such that the laser pulse source is controlled for transmitting modulated light in a predetermined time-bin, frequency, initial phase, amplitude and/or polarization state defined by user input bit or bits from the set of states with pre-defined frequency, initial phase, amplitude and/or polarization state (the alphabet). The user input is derived from any digital information that the user wants to communicate from transmitter 102 to receiver 104.

In some embodiments of the present invention, transmitter 102 includes an optical modulator optically interposed between, and in communication with, receiver 104 and laser source. In this manner, the optical modulator receives laser light from a laser source, receives an encoded signal from an encoder, modulates the laser light according to the encoded signal, and generates a transmitter signal from a laser light source modulated according to an encoded signal. It is contemplated that an encoder can include a source of digital information, bit or bits to modulate encoding, arbitrary signal generator to map digital information into modulated signals sequence and generate arbitrary control signals transmitted to an optical transmitter and can be a personal computer or application-specific integrated circuit or field programmable gate array mapping digital information into sequence of modulated signals and generating corresponding modulated signals. In an embodiment, encoder includes field programmable gate array or application-specific integrated circuit in conjugation to source of digital information. Encoded signal emitted by transmitter 102 typically includes a sequence (ensemble) of encoded pulses with each encoded pulse occurring during their own time period.

The encoded pulses can have different frequencies or phase gaps that separate intensities of temporally adjacent encoded pulses. Exemplary encoded pulses include sinusoidal radio frequency signals with modulated frequency and initial phase. The procedures of encoding, transmitting, receiving, and decoding encoded pulses are written for one pulse. The procedures of encoding, transmitting, receiving and decoding other encoded pulses can be the same. It is contemplated that transmitter 102 transforms encoded signal that can be, e.g., in a non-optical frequency regime such as radiofrequency (RF) into an optical signal with a particular modulation for every encoded pulse in encoded signal. In the exemplar embodiment, transmitter 102 transforms an encoder pulse into an optical pulse with a predetermined frequency (i.e., a selected optical frequency) and a predetermined initial phase based on the frequency and phase of the laser pulse. Additionally, a phase synchronization procedure can be run at pre-determined times between any two encoded pulses.

Transmitted signal from transmitter 102 can include optical pulses of an arbitrary temporal shape to carry digital information encoded in frequency and phase of the optical signal, and can be square laser pulses with constant intensity or Gaussian pulses. Transmitter 102 transmits the encoded transmitter signal to receiver 104 over optical communications channel 106. In some embodiments of the present invention, transmitter 102 and receiver 104 operate at the wavelength of about 1550 nm. In one embodiment, optical communications channel 106 is free-space optical communications channel, such as point-to-point, or satellite to ground, or satellite to satellite. In another embodiment, optical communications channel 106 is a fiber optic communications channel, such as a single mode optical fiber or multi-mode single-core or multi-core optical fiber. The optical pulse output from transmitter 102 is a coherent optical pulse. Transmitter 102 selects an input state ψₛ for output optical pulse according to information sent to the encoder using a predefined alphabet, or a set of states, sϵ1, . . . , M, and transmits the optical pulse to receiver 104. Number of bits of information that can be encoded in each optical pulse depends on alphabet length as log₂M. The ensemble of symbols prepared by transmitter 102 has a probability distribution of symbols known to receiver 104. In one embodiment, the stream of bits is padded with extra data to maintain the probability distribution of the symbols. In another embodiment, the stream of bits is compressed with a compression algorithm. In one embodiment, the ensemble of symbols that are prepared by transmitter 102 have an equal probability to transmit every symbol of the alphabet, which is equal to 1/M where M is the alphabet length.

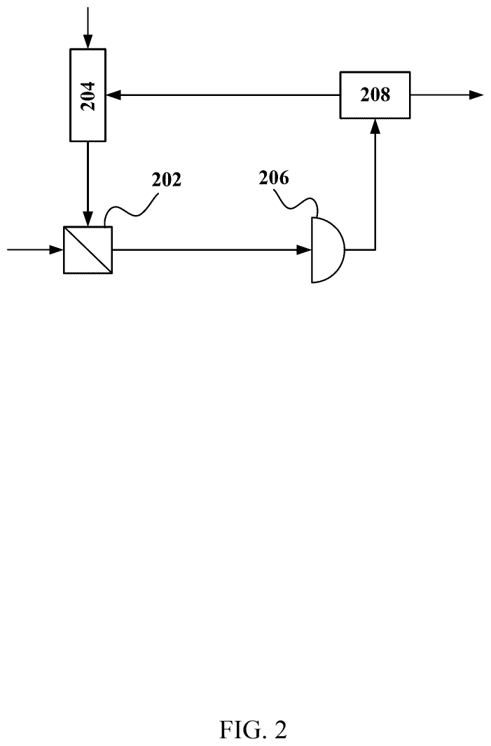

Receiver 104 receives an encoded optical signal transmitted from transmitter 102 over optical communications channel 106. Receiver 104 includes an optical and electronic circuits that receive the stream of modulated optical pulses from transmitter 102 over communications channel 106, detect the optical pulses, and generate appropriate signals that may be processed via a controller at receiver 104. In one embodiment, receiver 104 optical and electronic circuits include a beam splitter 202, local oscillator 204, single photon detector 206, and a processor 208 that can be a field-programmable gate array, as shown in FIG. 2. A processor 208 is capable of noting the time of the photon detections at detector 206, compute Bayesian probabilities and confidence vectors, and cause local oscillator 204 to generate an optical state with any one of the pre-determined modulations, corresponding the alphabet of the transmitter 102. At receiver 104, the incoming signal from transmitter 102 over communication channel 106 proceeds through beam splitter 202 to single photon detector 206. The input signal from transmitter 102 over communication channel 106 is combined with local oscillator 204 in beam splitter 202. The processor 208 can output the results of measurement on each symbol that include number and time of photon detections or clicks, the most likely symbol, and the confidence vector information associated with receiving each symbol.

Receiver 104 transmits a reference optical signal from local oscillator 204 to the beam splitter 202 to cancel the beam splitter 202 output signal by displacing the input encoded optical signal such that no photons are detected by detector 206. Mixing the reference optical signal from local oscillator 204 with the input signal at beam splitter 202 displaces the input encoded optical signal. If the frequency, initial phase, amplitude and polarization of reference optical signal from local oscillator 204 are in a specific relation to that of the input signal, then no optical signal is produced, which is known as destructive interference. Beam splitter 202 splits the input signal at a predetermined transmission to reflection (T:R) ratio. In one embodiment, beam splitter 202 splits the input signal at a T:R ratio of about 99:1 to provide a resulting output optical signal that is a combination of 99/100 parts of input signal with a 1/100 part of displacement signal. While any T:R ratio can be used, it is preferred to use beam splitter with T>>R for the encoded optical signal transmitted from transmitter 102 to maximize system efficiency of receiver 104. It is contemplated that local oscillator 204 intensity can be chosen to cancel signal input on a beam splitter 202 output. At the beginning of receiving each symbol, the reference optical signal from local oscillator 204 can be set to a state h₀ that corresponds to displacing the input signal's state with highest initial probability to vacuum. In one embodiment, the initial probability of all symbols are equal, so h₀ can be chosen at random.

If the frequency and initial phase of reference optical signal from local oscillator 204 is set to a state that does not correspond to displacing the input state to vacuum, then the displacement may lead to photon detection. If frequency or initial phase of the signal input and local oscillator 204 are different, optical signal carries a coherent state whose envelope may contain information transformed e.g. from frequency and/or initial phase into the amplitude of the envelope, and the amplitude can depend on time. The temporal dependence of said amplitude is unique for each combination of the frequencies and initial phases of input signal and displacement. Therefore, it contains additional information about the symbol that is represented by signal and the additional information about the confidence of an individual measurement. In case of faint optical signals, the modulus of the amplitude squared defines an average number of photons and consequently defines the probability of a photon detection with detector 206 at all times.

The output signal from beam splitter 202 is transmitted to single photon detector 206. No photons are detected by single-photon detector 206 or probability of the detection is very small when the modulation (the state from the modulation alphabet) of the reference beam from local oscillator 204 matches that of the input signal pulse. If the modulation state of the reference beam from local oscillator 204 does not match modulation of the input signal pulse, photons can be detected by single-photon detector 206. Photon detection indicates that receiver 104 most likely used an incorrect reference state from local oscillator 204 and that the reference state needs to be adjusted. Receiver 104 records the times of photon detection and uses the times of photon detection to adjust the modulation of the reference signal from local oscillator 204 to try to match the modulation of the input signal. In one embodiment, the plurality of Bayesian probabilities calculated for all M alphabet symbols at the time of the photon detection are used to find the most likely state hᵢ of the local oscillator 204 that corresponds to the state that yields the maximal Bayesian probability. In one embodiment, receiver 104 uses a combination of recorded detection times and the history of reference beam frequencies to determine all M Bayesian probabilities, known as a Confidence Vector.

To measure photon arrival times optical signal from beam splitter 202 is transmitted to single-photon detector 206, which may be a single-photon avalanche photodiode or a superconducting nanowire single-photon detector. Single-photon detector 206 generates electrical signal that can be a current or a voltage pulse having an amplitude that exceeds a certain threshold amplitude. Particularly, single-photon detector 206 selection can depend on wavelength of optical signal. More particularly, for visible range of 450 nm to 1000 nm, a silicone based single-photon avalanche photodiodes can be employed, for near infrared range from 1000 nm to 1700 nm germanium or indium gallium arsenide based single-photon avalanche photodiodes can be used. For both visible and near infrared ranges a superconducting nanowire single-photon detector can be used. Single-photon detector 206 signal can include electrical (voltage or current) pulses generated upon successful detection of a photon. Along with signature of successful detection provided by pulse amplitude when it exceeds threshold amplitude, rising or falling edges of these pulses can be used to obtain accurate information about photon arrival times.

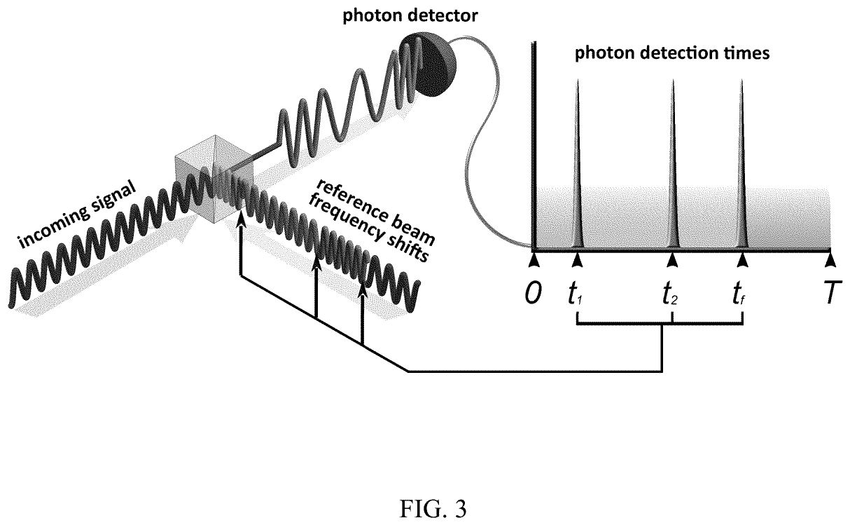

Each time a detection occurs, the signal produced by detector 206 is transmitted to processor 208. Processor 208 causes local oscillator 204 to adjust the modulation for the reference signal to a new state that corresponds to symbol with the highest Bayesian probability. The goal of the receiver 104 is to find the modulation to match the reference signal from local oscillator 204 to input optical signal, and therefore cancel optical input onto the detector 206. In this case the probability of the last state of local oscillator 204 that occurs at time t=T to match the symbol encoded in input state is the highest. In one embodiment, the processor 208 is a field programmable gate array. Additionally, in an embodiment, a field programable gate array can cause the local oscillator to generate a different modulated signal by generating modulated radio frequency pulses. Processor 208 determines Bayesian probabilities, stores and returns measurement records and confidence vectors. FIG. 3 illustrates exemplary time-resolved photon detections at single-photon detector 206 during the measurement. In one embodiment, although confidence vectors evolve in time, only photon-detection events lead to the hypothesis change. In this case, after each photon detection tᵢ, processor 208 recalculates the confidence vector \vec{P}(ϕₛ| [symbol] [0, tᵢ]) and switches the hypothesis to the state with the highest confidence hᵢ when there is a click on single-photon detector 206. The measurement history [symbol] [0, t] contains the history of each measurement of the symbol and is used to calculate \vec{P}. In one example, as shown in FIG. 3, [symbol] [0, t] contains single photon detections with detection times (t₁, t₂, t₃ in FIG. 3) and the history of all applied LO modulations (labeled as reference beam frequency shifts in FIG. 3). [symbol] [0, t] can be incomplete (t<T) and complete (t=T). In an embodiment, at the end of each measurement, the complete measurement history [symbol] [0, T] can be transferred to statistical processor 108 in real time in addition to \vec{P}(T). In another embodiment, only \vec{P}(T) and the number of photon detections from [symbol] [0, T] are transferred to statistical processor 108 in real time. Also, at time T, the identified state is transmitted to a digital signal processing unit 110. The identified state is the state corresponding to the component of vector \vec{P}(T) with the maximal value. The identified state carries user information that is being communicated. In another embodiment, the entire vector \vec{P}(T) is transmitted to a digital signal processing unit 110. This extra information can be used by the end user e.g. for the subsequent error correction.

Statistical processor 108 can be implemented with any digital signal processor such as common personal computer, server, or specifically designed hardware such as field programmable gate array paired with digital to analog converter or application-specific integrated circuit. A particular digital signal processing unit can be used to reach the desired communication rate, for example, a personal computer can provide communication rate up to few hundred kbit per second, field-programmable gate array—up to approximately 1 Gbit per second, and application-specific integrated circuit—to exceed 1 Gbit per second. Statistical processor 108 accumulates data for the duration of the ensemble and calculates statistical properties of \vec{P}(T). In an embodiment, statistical processor 108 calculates a probability to find a component of \vec{P}(T) in a certain range of values. In another embodiment, statistical processor 108 calculates a probability to receive a certain number of photons during identification of one transmitted symbol. Statistical processor 108 compares the calculated probabilities for the received ensemble of symbols to the probabilities theoretically expected from a communication system described by certain parameters (channel loss, channel phase noise, interferometric visibility at the receiver, dark count rate of the detector, etc.). In an embodiment, if a value of probability of a vector component to be in a certain range of values is greater or less than a certain threshold, the channel is declared as disturbed (or compromised). In another embodiment, the measured probabilities are used to calculate channel parameters.

A digital signal processing unit 110 in communication with both receiver 104 and statistical processor 108 is used to prepare received communicated data for the end user and output decisions on the state of the communication channel 106. A digital signal processor unit 110 can be implemented with any digital signal processor such as common personal computer, server, or specifically designed hardware such as field programmable gate array paired with digital to analog converter or application-specific integrated circuit. In an embodiment, digital signal processor unit 110 and statistical processor 108 can share hardware. In another embodiment, digital signal processor unit 110, statistical processor 108, and processor 208 of receiver 104 can share hardware.

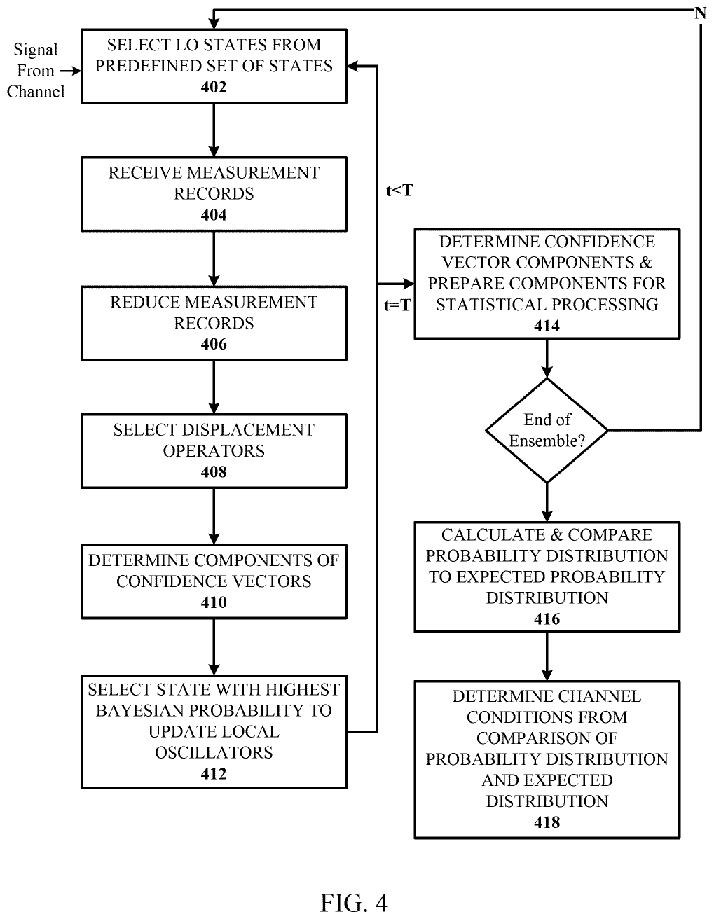

FIG. 4 illustrates a method for determining the input optical state and confidence vectors of optical communication channel 106 in accordance with embodiments of the present invention. Processor 108 first identifies the input state via a continuous quantum measurement, which finds the most likely transmitted value for the input state and the associated confidence vectors. The measurement employs adaptive displacement with feedback from single-photon detector 206. At step 402, processor 208 selects a local oscillator (LO) state from a predefined set of states, sϵ0, . . . , M−1 with a goal to displace the input state ϕₛ to vacuum with unknown s over time t=[0, T], where T is the duration of the input pulse to verify this displacement with a continuous measurement. The continuous measurement can be written as an operator:

$$\hat{Ω} = {lim}_{dt \to 0} ( {\hat{C}}_{T} {\hat{U}}_{T} \times … \times {\hat{C}}_{2 dt} {\hat{U}}_{2 dt} {\hat{C}}_{dt} {\hat{U}}_{dt} ) ,$$

where Û_{jdt} denotes a transformation, such as coherent displacement, applied to the input state under measurement on a time interval [(j−1)dt, jdt), where j=1, 2, . . . , N, dt=T/N, and Ĉ_{jdt} denotes photon counting during the same time interval dt. An outcome of such measurement is represented as a measurement record: [symbol] [0, T]=(λ₁, . . . , λ_{2dt}>λ_{2dt}; Ûₜ, . . . , Û_{2dt}, U_{dt}). The measurement record [symbol] [0, t], where t<T, is called an incomplete measurement record and measurement record [symbol] [0, T] is a complete measurement record.

At step 404, processor 108 receives the signal from single photon detector 206 and accumulates measurement history [symbol] [0, T]=(λ₁, . . . , λ_{2dt}>λ_{2dt}; Ûₜ, . . . , Û_{2dt}, U_{dt}) for each period T in full or in part. {λ_{jdt}} is the number and times of photodetection events and {Û_{jdt}} is the sequence of transformations. Transformations can be either pre-defined or adaptive. Pre-determined sequences {Û_{jdt}} are common for so-called unambiguous state discrimination problems, whereas adaptive transformations can be used to maximize the probability of successful state identification. In adaptive transformations, Û_{jdt} are not predefined and changes are based on detection of photons by single-photon detector 206. Due to probabilistic nature of photon detection, each measurement record is unique, even if the sequence of transformations is pre-defined. In one embodiment, the input states are optical coherent states that differ in phase as |ϕs [symbol] =|αe^{is2π/M} [symbol] and the displacement-based quantum measurement, Û=\hat{D}. In an embodiment, unreduced records [symbol] [0, T] are stored and transmitted to statistical processor 108 for further use.

From time to time, processor 208 reduces the measurement record. In an embodiment, the reduction of the measurement record occurs when processor 208 receives a photon detection information from detector 206. For input states that are optical coherent states, λ_{jdt}ϵ0,1, the interval dt can be sufficiently short such that multiphoton detections are improbable, and, at step 406, processor 208 reduces the measurement record to the list of photon detection times such that [symbol] [0,T]=(t₁, t₂, . . . , t_{f}; \hat{D}ₕ_{₀}, \hat{D}ₕ_{₁}, . . . , \hat{D}ₕ_{_{f}}), where \hat{D}ₕ_{₀} is the initial displacement, and hⱼ, jϵ1 . . . f are the displacements applied after j^{th} photon detection. For simplicity, it is assumed the displacement \hat{D}_{dt} can change only after the detection of a photon. In an embodiment, reduced records [symbol] [0, T] are stored and transmitted to statistical processor 108 for further use.

At step 408, processor 108 selects displacement operators to set local oscillator 204 with a goal to displace input state to vacuum. When properly matched, coherent displacement operators displace one of the input states to vacuum: \hat{D}ⱼ|ϕⱼ [symbol] =|vac [symbol] . Displacements are selected based on the optimization goal for state identification. State identification is achieved using a feedback mechanism in which, during the measurement, an incomplete detection record [symbol] [0, t] is used to select the most likely input state ś using the Bayesian inference t<T and set local oscillator 204 to displace input state ś to vacuum. When local oscillator 204 is set to displace input state ś to vacuum, the likelihood that detector 206 will click or detect a photon is close to zero if s=ś and is nonzero if the selection is incorrect (s≠ś).

To obtain confidence vectors, processor 108 analyzes the measurement record. The analysis of incomplete measurement records yields intermediate confidence values used for adaptive detection. The analysis of complete measurement records yields the received symbol and the confidence vector. The measurement record includes local operations on the input signal (such as displacement) and time stamps of detections at single-photon detector 206 assuming a noiseless channel or channel with a known level of noise 106 with a known loss. Such calculation can also include parameters of the receiver, such as non-ideal interference on beamsplitter 202 and dark count detection probability of detector 206. At step 410, processor 208 determines components of confidence vectors, wherein each component corresponds to an input signal's state and is the probability that the measurement record occurs if the input was in that state. For a communication signal having M states ϕₛ, sϵ0, . . . , M−1, confidence vector has M components with each component being a Bayesian probability with probabilities ranging from 0 to 1. The confidence vector \vec{P}={pₛ} for an incomplete record includes probabilities pₛ=p( [symbol] [0, t]|ϕₛ) that a measurement record [symbol] [0, t] occurs for the input state ϕₛ t<T. Probabilities pₛ is computed using the Bayes formula:

$$p ( {ϕ}_{s} \vert ℤ [ 0 , t ] ) = \frac{p ( ℤ [ 0 , t ] \vert {ϕ}_{s} ) {\tilde{p}}_{s}}{p ( ℤ [ 0 , t ] )} \qquad ( 1 )$$

To find complete probabilities t is replaced by T in Equation (1). A vector of a priori probabilities \vec{P}ₜ₌₀={\tilde{p}ₛ} is the vector of probabilities to encounter an input state ϕₛ, which is typically known. In one embodiment, at the beginning of signal pulse, all encoded signal states characterized by the same a priori probability 1/M, where M is the length of alphabet, so the initial guess is set to any of these states at time t=0. If photon arrival time occurs before signal pulse end time, processor 108 records this arrival time and generates feedback signal with a modulation that corresponds to the most probable state of input signal conditioned on this arrival time and all previous arrival times. If no photons arrive after setting a feedback signal and before next time period, statistical processor 108 retains a decoded signal corresponding to the last update of the feedback. A vector of confidences is formed using probability values \vec{P}={p(ϕₛ| [symbol] [0, t])}, whose components represent the best knowledge about the input state during (t<T) and after (t=T) measurement. In one embodiment, the above hypothesis, or displacement \hat{D}_{dt}, can be updated only after a detection of a photon at time tⱼ.

To update the displacement \hat{D}_{dt}, method in accordance with embodiments of the present invention first determines posterior probabilities that the input state is ϕₛ for the incomplete record [symbol] [0, tⱼ] using Equation (1). Method in accordance with embodiments of the present invention then selects, at step 412, the state with the highest Bayesian probability to update local oscillator 204. At time t=0, the displacement \hat{D}_{dt} at local oscillator 204 is set to any state because all components of \vec{P}ₜ₌₀ are the same. In an embodiment, local oscillator 204 is initially set to state hₜ₌₀=0.

The displacement \hat{D}_{dt} causes interference in the unknown input state at local oscillator 204. The model for calculating the conditional probabilities p( [symbol] [0, tⱼ]|ϕₛ), as shown in Equation (1), can account for imperfect interference and dark counts on the detector.

If the probability of dark counts is low, then a posteriori probabilities p(ϕₛ| [symbol] [0, tⱼ]) can be calculated based on a priori probabilities p(ϕₛ| [symbol] [0, tⱼ₋₁]) by recursively using the following simplified expression for Bayesian probabilities:

$$p ( {ϕ}_{s} \vert ℤ [ 0 , {t}_{j} ] ) = \frac{p ( ℤ [ {t}_{j - 1} , {t}_{j} ] \vert {ϕ}_{s} ) p ( {ϕ}_{s} \vert ℤ [ 0 , {t}_{j - 1} ] )}{{\sum }_{k = 1}^{M} p ( ℤ [ {t}_{j - 1} , {t}_{j} ] \vert {ϕ}_{k} ) p ( {ϕ}_{k} \vert ℤ [ 0 , {t}_{j - 1} ] )} , \qquad ( 3 )$$

where the Bayesian likelihood p( [symbol] [tⱼ₋₁, tⱼ]|ϕₛ) is the probability density to detect a photon at time tⱼ if the previous photon is detected at time tⱼ₋₁ and the displacement \hat{D}_{dt} at local oscillator 204 is set to hⱼ₋₁ and the signal input state is ϕₛ. In an exemplary embodiment, the likelihood is:

$$p ( ℤ [ {t}_{j - 1} , {t}_{j} ] \vert {ϕ}_{s} ) = ( 〈 n ( s , {h}_{j - 1} ) 〉 / T ) {e}^{- 〈 n ( s , {h}_{j - 1} ) 〉 ( {t}_{j} - {t}_{j - 1} ) / T} \qquad ( 4 )$$

$$and$$

$$〈 n ( s , h ) 〉 = 2 𝒯 {n}_{0} ( 1 - v cos [ ( h - s ) π / 2 ] ) , \qquad ( 5 )$$

where n₀=|α|² is the mean photon number in the signal pulse, [symbol] =0.99≈1 is the transmittance of the unbalanced beam splitter, and v is interference visibility. Once the complete measurement record is obtained, the confidences are determined using Equation (1) after substituting Equations (3) and (4). Other modifications to formula (4) and (5) can be applied to account for known assumptions about transmitter 102, receiver 104, and communication channel 106, as desired. Processor 208 can accumulate and send values of the confidence vector to the statistical processor 108 for further statistical analysis if desired. At step 414, at the time t=T values of confidence vector are found, stored, and transmitted to the statistical processor 108 for further analysis.

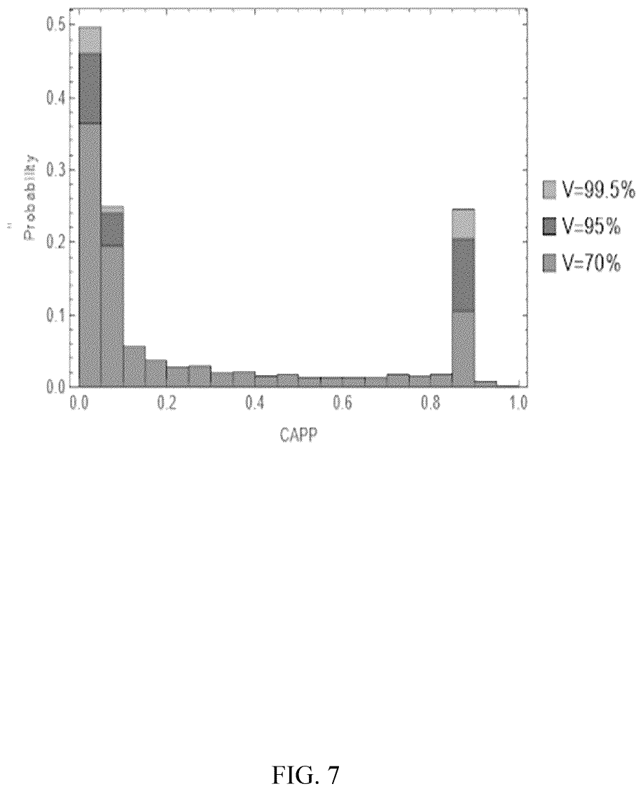

Statistical processor 108 receives the information of each measurement for analysis, statistical verification, and visualization. Statistical processor 108 can receive from processor 208 any of the following: received signals, times of photon detections, history of applied displacement operators, and the final confidence vector. The photon arrival times can be used to calculate a posteriori probabilities of signal frequency independently from processor 208 if desired. Processor 108 statistically processes the received information for an ensemble of symbols and uses those values to determine if the communication link is affected by additional noise or to detect an unexpected change in communication channel optical losses. Examples of such information include the probability that the components of the final confidence vector fall within a certain range of values and the probability for the receiver to detect a specific number of photons during receiving one symbol. Processor 108 can be implemented with any digital signal processing unit such as common personal computer or server or specifically designed hardware such as field programmable gate array paired with digital to analog converter or application-specific integrated circuit. A particular digital signal processing unit can be used to reach the desired communication rate, for example, a personal computer can provide communication rate up to few hundred kbit per second, field-programmable gate array—up to 1 Gbit per second, and application-specific integrated circuit to exceed 1 Gbit per second. In an embodiment, processor 108 can be co-located in the same physical processing unit, such as an FPGA as the processor 208. At step 416, method in accordance with embodiments of the present invention determines the probability distribution of confidence vector component values over an ensemble of state identifications and the probability of measurement outcomes with greater than (M−1) photon detections. To do so, confidence values and the number of symbol measurements that resulted in detection of more than (M−1) photons are considered for a desired ensemble of symbol measurements. The exact number of symbols in the ensemble is determined to ensure a sufficient statistical accuracy: larger ensembles produce better accuracy. Better accuracy is generally needed to monitor for smaller channel disturbances. In one embodiment, the optimal size of the ensemble can be determined using Allan variance analysis. In one embodiment, values of all M components of each confidence vector in the ensemble are distributed into a histogram of values. The histogram spawns the probability values from 0 to 1. Bin sizes for the histogram are determined to optimize the statistical uncertainty and depend on the ensemble size, the detection threshold of a channel disturbance measure, the number of photons per symbol, the alphabet size, and other parameters. In one embodiment, 20 bins with a size of 0.05 are used to cover the interval of probabilities from 0 to 1, see FIG. 7. In another embodiment 10 bins with a size of 0.1 are used.

Also at step 416, statistical processor 108 compares the measured probability distribution to the expected probability distribution for a noiseless channel with the same known loss. If any of the statistical properties significantly deviate from the expected values, then, at 418, statistical processor 108 determines that the channel conditions are different from the assumption and that channel 106 is not a noiseless channel or that known level of noise has changed (phase disturbance, interferometric visibility, etc. has changed) or that channel does not deliver an expected average number of photons per symbol (due to the change of transmission channel optical losses) to the receiver per each symbol. To do so, statistical processor 108 compares expected statistical values and observed statistical values while determining the statistical uncertainty of the observed values. Any detection threshold will be reliable within such statistical uncertainty. By observing a combination of statistical values, such as probability of getting confidences close to unit or the probability of detecting more than (M−1) photons per symbol at the receiver, phase disturbance and energy disturbance can be separated. Method in accordance with embodiments of the present invention determines statistical deviations of the received degrees of belief from expected degrees of belief locally at receiver 104, without the need for any data reconciliation or additional information exchange. Unlike classical techniques, in addition to determining the degree of phase and/or energy disturbance, the maximal amount of information shared with the eavesdropper can be bounded from above using the no-cloning theorem and the Helstrom bound for a specific encoding.

If laws of quantum measurement, i.e. Helstrom bound calculations are to be used to estimate the possible information leakage from the channel under measurement, for accuracy of this estimation, the ensemble of symbols used for detecting channel disturbances should not contain any error-correcting information. Error correction and data reconciliation data, important for successful data transfer occurs in one of the following ensembles of symbols. For example, if repetition code is used for error correction where the same message is repeated several times, the ensemble used to detect disturbances should only contain a unique message, and this message may be repeated in the following ensembles of systems.

If statistical processor 108 detects energy per bit reduction, that is attributed to the beam splitting attack of the eavesdropper. Then, by using the Helstrom bound, and the amount of energy per bit that is missing on the receiver give the lower bound of the error rate by the eavesdropper, which yields the bound on a fraction of the information that could have been leaked and successfully received by the eavesdropper.

If statistical processor detects phase disturbance, that can be attributed to the amplifier in the channel. Then a no-cloning theorem and the Helstrom bound can be used to find the bound on the fraction of information that could have been leaked and successfully received by the eavesdropper.

Separately from physical channel monitoring described above, if, during information reconciliation stage the number of corrected errors at the receiver is significantly larger than anticipated from the calculated error rate for a channel with loss and noise measured by statistical processor 108, a man-in-the-middle attack, where the eavesdropper fully intercepts, measures and regenerates the optical signal is detected. This is because Helstrom bound necessities that an eavesdropper will receive at least a certain number of symbols (or more) with error. Therefore, the number of errors will be larger at receiver 104 after an error correction/reconciliation process than the expected number. Any error correction and reconciliation method can be used, provided that no error correcting information is distributed within the ensemble of symbols that is used for channel disturbance detection.

Digital signal processing unit 110 combines the communicated raw information received from transmitter 102 by receiver 104, and the computed measurement of the state of communication channel 106 performed by statistical processor 108. Digital signal processing unit 110 uses the above information to make a decision to continue communication or break communication due to e.g. suspicion that the channel is compromised. It also can perform error correction and make the information available for the end user or application. In one embodiment, digital signal processing unit 110 also receives all components of the confidence vector P and use that information for more efficient error correction.

Reference now to the specific examples which follow will provide a clearer understanding of systems in accordance with embodiments of the present invention. The examples should not be construed as a limitation upon the scope of the present invention.

### Example 1. In-Situ Channel Monitoring Via Quantum Measurement

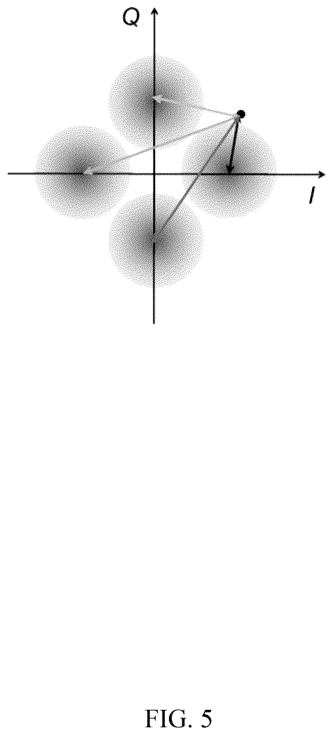

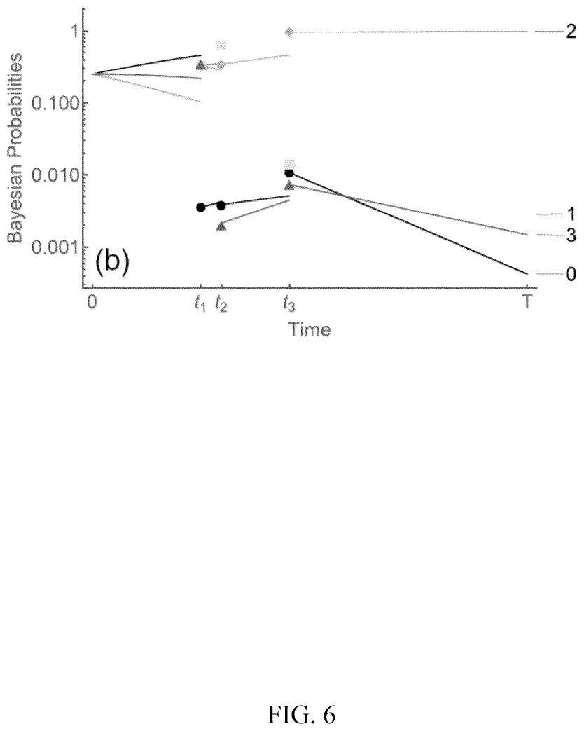

In an experimental setup for in-situ channel monitoring using system and method in accordance with embodiments of the present invention, a communication signal having M=4 coherent states that are modulated in phase (quadrature phase shift keying (QPSK)) and optical energy (mean photon number) of 1 photon/bit is selected. FIG. 5 illustrates an exemplary constellation diagram of M=4 coherent states that are modulated in phase and FIG. 6 illustrates an example of the simulated Bayesian probabilities \vec{P}(t) in a single-shot measurement that uses the time resolved displacement quantum receiver from FIG. 3.

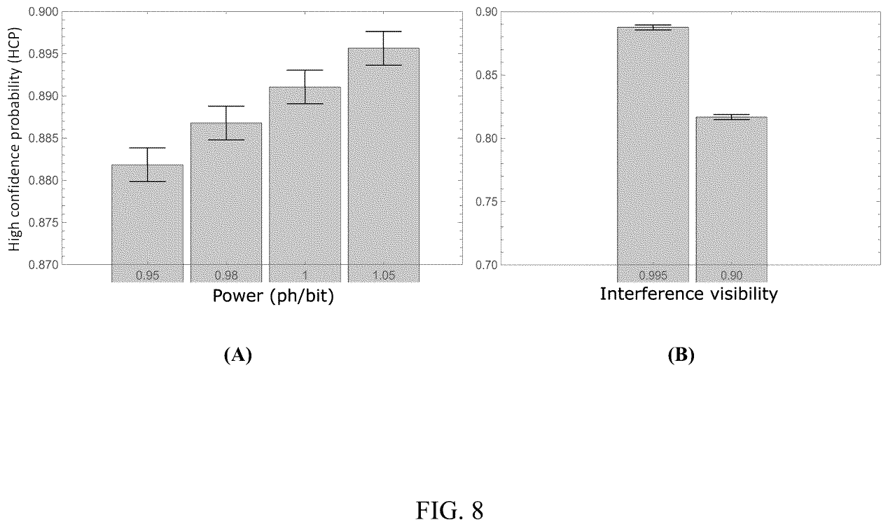

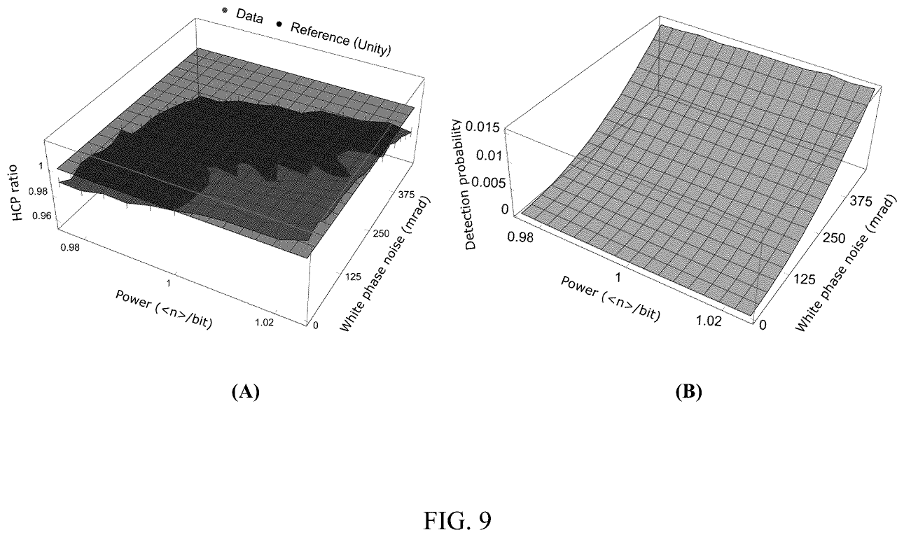

The communication is transmitted over an optical communication channel and received at a time-resolved quantum receiver. A quantum estimator computes the probability distribution of the confidence vector component values obtained from the measurement of one million symbols. The confidence vector includes four Bayesian probabilities corresponding to the four states in the QPSK modulation. The highest value of confidence is our best guess for the received data. The statistical probability (frequency) to obtain certain values of the confidence vector significantly depend on how the actual channel conditions (loss and phase noise) differ from those assumed. Indeed, the simulation shows that the probability to measure confidence values within a certain range changes with the visibility of the channel (phase noise). A histogram with bin size of 0.05, FIG. 7 shows that for low and certain high values of confidence this probability changes significantly. For example, see the bin with high confidence, i.e. the height of the 0.85-0.9 bin of the histogram. Other bins can be used, depending on the specific parameters of the channel and the alphabet. In FIGS. 8, 9 and 10, the maximal confidence vector component is between is from about 0.9 to about 1, and this parameter is referred to as High Confidence Probability (HCP). FIGS. 8A-8B illustrate the measured HCP for channels with different disturbances: (A) energy per bit (average power in the channel) and (B) interference visibility, correlated with uncontrolled phase noise, for an exemplary channel monitoring system in accordance with embodiments of the present invention. FIGS. 9A and 9B illustrate the simulation results of the dependence on the transmission channel parameters (loss, expressed as received energy per bit and white phase noise expressed in mrad RMS) of (A) HCP ratio, defined as the probability to obtain a High Confidence measurement in the channel with assumed characteristics (e.g. given energy per bit, given phase noise, given interferometric visibility, given dark count noise on the single photon detector and so on) divided by theoretically expected probability to obtain a High Confidence measurement probability. and (B) Excess photon detection probability (probability of more than (M−1) photon detections per symbol obtained for an ensemble of detected symbols, where M is the number of states in the alphabet of an exemplary channel monitoring system in accordance with embodiments of the present invention. In (B) the probability to detect more than 4−1=3 photons is obtained. Typically, in the noiseless channel, one need to invalidate no more than (M−1) hypothesis of M possible to find the correct one. Therefore, for noiseless communication channel quantum receiver need to detect (M−1) or fewer photons to identify the received state. If more photons were detected, that means that there is additional noise in the communication channel or receiver. In this example we use the excess photon detection probability to detect phase noise in the communication channel. Experiments and simulations show that those probability values (represented as the height of the bin) correlate with input power and phase noise, as shown in FIGS. 8, 8A, and 8B.

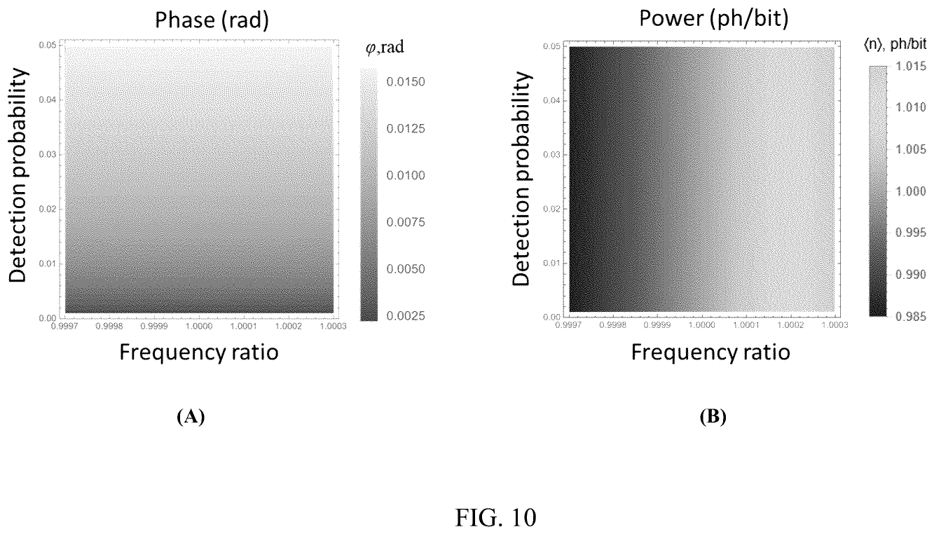

Given the uncertainties obtained in the experiment, estimator can resolve sustained power fluctuations as small as 2%, which translates to sensitivity to just 0.02 photons per bit (or 2.6×10⁻²¹ J/bit) energy disturbance in the channel by monitoring the deviation of the frequency of high-confidence outcomes from the reference point, which can be used to define a monitoring energy threshold. In simulations, even better resolutions (as small as 0.5% or 0.005) were obtained (FIGS. 9A and 10B).

Similarly, the monitoring scheme was tested against the phase noise. White phase noise was experimentally emulated by reducing interferometric visibility between the signal and local oscillator. FIGS. 8A, 8B, and 9A illustrate the experimental results that the high-confidence probability is sensitive to both power and phase fluctuations.

Although this property can be used as an alarm for changing channel conditions, it is useful to separate the power and phase contributions. The results provide an initial indication that along with high confidence probability, other metrics such as the number of clicks obtained during measurements may enable the alarm. FIG. 9B shows simulation results for the probability of detecting more than M−1=4−1=3 clicks (excess photon probability), which increase with the phase noise in the channel, but are relatively less sensitive to the loss in the communication channel. At the same time high-confidence probability is less sensitive to the phase noise than to the loss in the communication channel.

Together these two observables allow to approximate phase noise and the loss in the communication channel from the high-confidence probability and excess photon probability, as shown in FIGS. 10A and 10B.

Additional examples that provide a clearer understanding of systems and methods in accordance with embodiments of the present invention include those disclosed in “Burenkov, I., Annafianto, N., Jabir, M., Wayne, M., Battou, A., & Polyakov, S. (2022). Experimental Shot-by-Shot Estimation of Quantum Measurement Confidence. Phys. Rev. Lett., 128, 040404” and “Jabir, M., Annafianto, N., Battou, A., Burenkov, I., & Polyakov, S. (2023). Modulation-agnostic single-shot estimation of quantum measurement confidence. Phys. Rev. A, 108, 052203”, the disclosure of which is incorporated herein by reference.

Optical communication channel monitoring system and method in accordance with embodiments of the present invention have several advantages over previous channel monitoring systems. Optical communication channel monitoring system and method in accordance with the present invention is capable of estimating channel loss and added phase noise based on the quantum properties of faint light. In addition, quantum theory of measurement enables one to estimate the upper bound (maximal) possible information leak. All measurements utilizing system and method in accordance with embodiments of the present invention are local to the receiver, and additional information (or physical states) exchange between transmitter and receiver (or between receiver and transmitter) is not required for the core method. System and method in accordance with embodiments of the present invention can be combined with other techniques, such as quantum key distribution, quantum channel protection, quantum position verification, and others to enhance those techniques and for added protection against an adversary. Embodiments in accordance with the present invention are capable of quantifying the communication channel properties as they pertain to the classical data exchange.

Optical communication channel monitoring system and method in accordance with embodiments of the present invention can be adapted to a variety of configurations. It is thought that optical communication channel monitoring system and method in accordance with various embodiments of the present invention and many of its attendant advantages will be understood from the foregoing description and it will be apparent that various changes may be made without departing from the spirit and scope of the invention or sacrificing all of its material advantages, the form hereinbefore described being merely a preferred or exemplary embodiment thereof.

Those familiar with the art will understand that embodiments of the invention may be employed, for various specific purposes, without departing from the essential substance thereof. The description of any one embodiment given above is intended to illustrate an example rather than to limit the invention. This above description is not intended to indicate that any one embodiment is necessarily preferred over any other one for all purposes, or to limit the scope of the invention by describing any such embodiment, which invention scope is intended to be determined by the claims, properly construed, including all subject matter encompassed by the doctrine of equivalents as properly applied to the claims.

What is claimed is:

1. A system for monitoring an optical communication channel, said system comprising:
a transmitter for generating an encoded input optical signal, wherein the encoded input optical signal is transmitted over the optical communication channel, wherein the encoded input optical signal comprises a plurality of encoded input optical signal states;
a receiver for receiving the encoded input optical signal transmitted over the optical communication channel, wherein the receiver comprises:
a local oscillator for generating a reference optical signal comprising a plurality of displacement operators for displacing at least one of the plurality of the encoded input optical signal states;
a beam splitter for splitting the encoded input optical signal at a predetermined transmission to reflection ratio to generate a displaced output optical signal, wherein the encoded input optical signal is combined with the reference optical signal at the beam splitter to generate the displaced output optical signal, wherein the displaced output optical signal has zero optical energy when the encoded input optical state matches the reference optical signal, and wherein the displaced output optical signal has non-zero optical energy when the encoded input optical signal does not match the reference optical signal;
a single photon detector in communication with the beam splitter and that:
receives the displaced output optical signal from the beam splitter; and
produces a single photon detector signal based on the displaced output optical signal;
a first processor for determining a plurality of confidence vectors of an optical state identification for the at least one of the plurality of the encoded input optical signal states of the encoded input optical signal transmitted over the optical communication channel, wherein the determining the plurality of the confidence vectors of the optical state identification comprises determining a plurality of components for each of the plurality of the confidence vectors, wherein the each of the plurality of the components corresponds to the at least one of the plurality of the encoded input optical signal states and a probability of occurrence of at least one of a plurality of measurement records corresponding to the at least one of the plurality of the encoded input optical signal states for the encoded input optical signal; and
a second processor for analyzing at least one of the plurality of the confidence vectors determined by the first processor, wherein the analyzing the at least one of the plurality of the confidence vectors comprises:
determining a probability distribution of the plurality of the components for the each of the plurality of the confidence vectors over the plurality of the encoded input optical signal states; and
comparing the probability distribution of the plurality of the components for the each of the plurality of the confidence vectors over the plurality of the encoded input optical signal states with a second probability distribution of a plurality of second components for each of a plurality of second confidence vectors over a plurality of expected optical states traversing the optical communication channel comprising at least one of a plurality of reference properties.

2. The system of claim 1, wherein the first processor adjusts the reference optical signal to generate an adjusted reference optical signal.

3. The system of claim 2, wherein the first processor adjusts the reference optical signal in response to detecting the single photon detector signal at the single photon detector, wherein the adjusted reference optical signal corresponds to the at least one of the plurality of the encoded input optical states having a maximal value of the confidence vector.

4. The system of claim 1, wherein the first processor generates a radio frequency signal pulse to adjust the reference optical signal.

5. The system of claim 1, wherein the analyzing the at least one of the plurality of the confidence vectors further comprises:
determining at least one of a plurality of probabilities of measurement outcomes with a predetermined plurality of detections at the single photon detector; and
comparing the at least one of the plurality of probabilities of measurement outcomes to a probability of the expected optical states traversing the optical communications channel comprising the at least one of the plurality of the reference properties.

6. The system of claim 1, wherein the first processor is a field programmable gate array.

7. The system of claim 1, wherein the second processor is a statistical processor.

8. The system of claim 1, wherein each of the plurality of the measurement records comprises a record of the plurality of the displacement operators selected for displacing the at least one of the plurality of the encoded input optical signal states of the received encoded input optical signal and time stamp of the generation of the displaced output optical signal.

9. The system of claim 1, 2, 3, or 5, wherein the at least one of the plurality of the reference properties is selected from a group comprising channel loss, channel phase noise, interferometric visibility, and dark count rate of the detector.

10. A method for monitoring an optical communication channel, comprising:
generating at a transmitter an encoded input optical signal, wherein the encoded input optical signal is transmitted over the optical communication channel, wherein the encoded input optical signal comprises a plurality of encoded input optical signal states;
receiving at a receiver the encoded input optical signal transmitted over the optical communication channel;
generating at a local oscillator a reference optical signal comprising a plurality of displacement operators for displacing at least one of the plurality of the encoded input optical signal states of the received encoded input optical signal;
splitting at a beam splitter the encoded input optical signal at a predetermined transmission to reflection ratio to generate a displaced output optical signal, wherein the encoded input optical signal is combined with the reference optical signal at the beam splitter to generate the displaced output optical signal, wherein the displaced output optical signal has zero optical energy when the encoded input optical state matches the reference optical signal, and wherein the displaced output optical signal has non-zero optical energy when the encoded input optical signal does not match the reference optical signal;
detecting at a single photon detector a single photon detector signal, wherein the detecting the single photon detector signal comprises receiving the displaced output optical signal from the beam splitter and producing the single photon detector signal based on the displaced output optical signal;
determining at a first processor a plurality of confidence vectors of an optical state identification for the at least one of the plurality of the encoded input optical signal states of the encoded input optical signal transmitted over the optical communication channel, wherein the determining the plurality of the confidence vectors of the optical state identification comprises determining a plurality of components for each of the plurality of the confidence vectors, wherein the each of the plurality of the components corresponds to the at least one of the plurality of the encoded input optical signal states and a probability of occurrence of at least one of a plurality of measurement records corresponding to the at least one of the plurality of the encoded input optical signal states for the encoded input optical signal; and
analyzing at a second processor at least one of the plurality of the confidence vectors determined at the first processor, wherein the analyzing the at least one of the plurality of the confidence vectors comprises:
determining a probability distribution of the plurality of the components for the each of the plurality of the confidence vectors over the plurality of the encoded input optical signal states; and
comparing the probability distribution of the plurality of the components for the each of the plurality of the confidence vectors over the plurality of the encoded input optical signal states with a second probability distribution of a plurality of second components for each of a plurality of second confidence vectors over a plurality of expected optical states traversing the optical communication channel comprising at least one of a plurality of reference properties.

11. The method of claim 10, further comprising adjusting at the first processor the reference optical signal to generate an adjusted reference optical signal.

12. The method of claim 11, wherein the reference optical signal is adjusted at the first processor in response to detecting the single photon detector signal at the single photon detector, wherein the adjusted reference optical signal corresponds to the at least one of the plurality of the encoded input optical states having a maximal value of the confidence vector.

13. The method of claim 10, further comprising generating at the first processor a radio frequency signal pulse to adjust the reference optical signal.

14. The method of claim 10, wherein the analyzing the at least one of the plurality of the confidence vectors further comprises:
determining at least one of a plurality of probabilities of measurement outcomes with a predetermined plurality of detections at the single photon detector; and
comparing the at least one of the plurality of probabilities of measurement outcomes to a probability of the expected optical states traversing the optical communications channel comprising the at least one of the plurality of the reference properties.

15. The method of claim 10, further comprising:
selecting at least one of the plurality of the components having a predetermined probability; and
transmitting the at least one of the plurality of the selected components to the local oscillator.

16. The method of claim 10, further comprising:
generating at the first processor the plurality of the measurement records, wherein each of the plurality of the measurement records comprises a record of the plurality of the displacement operators selected for displacing the at least one of the plurality of the encoded input optical signal states of the received encoded input optical signal and time stamp of the generation of the displaced output optical signal;
storing at the first processor the generated plurality of the measurement records; and
reducing the plurality of the measurement records to a list comprising a plurality of photon detection times.

17. The method of claim 10, 11, 12 or 14 wherein the plurality of the reference properties is selected from a group comprising channel loss, channel phase noise, interferometric visibility, and dark count rate of the detector.

18. A method for monitoring an optical communication channel, comprising:
receiving at a receiver an encoded input optical signal transmitted by a transmitter over the optical communication channel, wherein the encoded input optical signal comprises a plurality of encoded input optical signal states;
generating at a local oscillator a reference optical signal comprising a plurality of displacement operators for displacing at least one of the plurality of the encoded input optical signal states of the received encoded input optical signal;
splitting at a beam splitter the encoded input optical signal at a predetermined transmission to reflection ratio to generate a displaced output optical signal, wherein the encoded input optical signal is mixed with the reference optical signal at the beam splitter to generate the displaced output optical signal, wherein the displaced output optical signal has zero optical energy when the encoded input optical state matches the reference optical signal, and wherein the displaced output optical signal has non-zero optical energy when the encoded input optical signal does not match the reference optical signal;
detecting at a single photon detector a single photon detector signal, wherein the detecting the single photon detector signal comprises receiving the displaced output optical signal from the beam splitter and producing the single photon detector signal based on the displaced output optical signal;
adjusting at a first processor the reference optical signal to generate an adjusted reference optical signal, wherein the reference optical signal is adjusted in response to the detection of the single photon detector signal at the single photon detector, wherein the adjusted reference optical signal corresponds to the at least one of the plurality of the encoded input optical states having a maximal value of the confidence vector;
determining at the first processor a plurality of confidence vectors of an optical state identification for the at least one of the plurality of the encoded input optical signal states of the encoded input optical signal transmitted over the optical communication channel, wherein the determining the plurality of the confidence vectors of the optical state identification comprises determining a plurality of components for each of the plurality of the confidence vectors, wherein the each of the plurality of the components corresponds to the at least one of the plurality of the encoded input optical signal states and a probability of occurrence of at least one of a plurality of measurement records corresponding to the at least one of the plurality of the encoded input optical signal states for the encoded input optical signal;
selecting at least one of the plurality of the components having a predetermined probability;
transmitting at least one of the plurality of the confidence vectors of the optical communication channel; and
analyzing at a second processor the at least one of the plurality of the confidence vectors determined at the first processor, wherein the analyzing the at least one of the plurality of the confidence vectors comprises:
determining a probability distribution of the plurality of the components for the each of the plurality of the confidence vectors over the plurality of the encoded input optical signal states; and
comparing the probability distribution of the plurality of the components for the each of the plurality of the confidence vectors over the plurality of the encoded input optical signal states with a second probability distribution of a plurality of second components for each of a plurality of second confidence vectors over a plurality of expected optical states traversing the optical communication channel comprising at least one of a plurality of reference properties.

19. The method of claim 18, further comprising generating at a transmitter the encoded input optical signal.

20. The method of claim 18, further comprising:
generating at the first processor a plurality of measurement records, wherein each of the plurality of the measurement records comprises a record of the plurality of the displacement operators selected for displacing the at least one of the plurality of the encoded input optical signal states of the received encoded input optical signal and time stamp of the generation of the displaced output optical signal;
storing at the first processor the generated plurality of the measurement records; and
reducing the plurality of the measurement records to a list comprising a plurality of photon detection times.

21. The method of claim 18, wherein the adjusting the reference optical signal comprises generating at the first processor a radio frequency signal pulse.

22. The method of claim 18, wherein the plurality of the reference properties is selected from a group comprising channel loss, channel phase noise, interferometric visibility, and dark count rate of the detector.
